(19) United States
(12) Patent Application Publication
(10) Pub. No.: US 2008/0219737 A1
(43) Pub. Date: Sep. 11, 2008

(54) Hand Held Printer Having A Doppler Position Sensor

(76) Inventors: Michael David Stilz, Lexington, KY (US); Maini Helena Williams, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/682,900

(22) Filed: Mar. 7, 2007

(51) Int. Cl. B41J 3/36; B41J 29/38

(52) U.S. Cl. 400/76; 400/88

(57) ABSTRACT

A hand held printer for printing on a print medium includes a body. A printhead is fixedly mounted to the body of the hand held printer. A Doppler position sensor is mounted to the body. A controller is communicatively coupled to each of the printhead and the Doppler position sensor. The controller executes program instructions to read a velocity signal received from the Doppler position sensor and processes the velocity signal to determine a position of the printhead on the print medium relative to at least one of a first axis and a second axis.

### BACKGROUND OF THE INVENTION

1. Field of the Invention

The present invention relates to hand held printers, and, more particularly, to a hand held printer having a Doppler position sensor for detecting a position of the hand held printer with respect to a print medium.

2. Description of the Related Art

A typical desktop ink jet printer includes a drive mechanism for physically positioning a print element, e.g., an ink jet printhead, relative to a print medium, such as a sheet of paper, and includes a media feed system for feeding the print medium. This relative movement of paper and print element is the traditional configuration for digital printers.

More recently, efforts have been directed to printing using a hand held printer. A hand held printer, also sometimes referred to as a hand-operated printer, is a printer that mounts a printhead and ink supply, which may be in the form of an ink jet printhead cartridge, wherein the printer itself is moved relative to the print medium to position the printhead relative to the print medium. Thus, unlike a typical desktop printer, the hand held printer does not include a drive mechanism for physically positioning the printhead relative to the print medium, not does a hand held printer include a media feed system for feeding a sheet of print media.

The hand held printer may be configured to activate print whenever the area under the print element matches an unprinted section of the latent image to be printed. However, such a random motion printer requires an accurate position sensing mechanism to determine the position of the print element relative to the print medium. One such hank held printer employs a small digital camera having expensive custom optics and a complex computational algorithm that detects typographic structure on the paper and through intensive calculation tracks artifacts through the field of view from multiple images.

Another approach uses an optical sensor to provide position data for firing the printhead by sensing the relative motion of the hand held printer relative to the print medium. Optical sensors detect the typography of the fibrous paper surface by looking at the shadows from low angle illumination. Prior art hand held printers use sophisticated digital signal processing algorithms to analyze the multi-pixel image data received from a photodetector of the optical sensor, looking for pattern changes that suggest motion of the hank held printer relative to the print medium.

### SUMMARY OF THE INVENTION

The terms “first” and “second” preceding an element name, e.g., first Doppler sensor, second Doppler sensor, etc., are used for identification purposes to distinguish between similar elements, and are not intended to necessarily imply order, nor are the terms “first” and “second” intended to preclude the inclusion of additional similar elements.

Also, as used herein, the terms “horizontal” and “vertical” corresponds to directions within or parallel to the plane of print medium, such as a sheet of paper, unless otherwise specified.

The invention, in one form thereof, is directed to a hank held printer for printing on a print medium. The hank held printer includes a body. A printhead is fixedly mounted to the body of the hand held printer. A Doppler position sensor is mounted to the body. A controller is communicatively coupled to each of the printhead and the Doppler position sensor. The controller executes program instructions to read a velocity signal received from the Doppler position sensor and processes the velocity signal to determine a position of the printhead on the print medium relative to at least one of a first axis and a second axis.

The invention, in another form thereof, is directed to a hand held printer for printing on a print medium. The hand held printer includes a body. A printhead is fixedly mounted to the body of the hand held printer. The printhead has a plurality of ink jetting nozzles. A first Doppler sensor is mounted to the body. The first Doppler sensor generates a first velocity signal related to motion of the hank held printer along a first axis. A second Doppler sensor is mounted to the body, and is spaced apart from the first Doppler position sensor. The second Doppler sensor generates a second velocity signal related to motion of the hand held printer along a second axis. A controller is communicatively coupled to each of the printhead, the first Doppler sensor, and the second Doppler sensor. The controller executes program steps to process the first velocity signal and the second velocity signal through an integration calculation, and determine a relative position of the printhead on the print medium alone the first axis and the second axis with respect to an object.

The invention, in another form thereof, is directed to a method for determining a position of a printhead on a print medium. The method includes generating a first velocity signal related to motion of the hand held printer along a first axis using a first Doppler sensor; generating a second velocity signal related to motion of the hand held printer along a second axis using a second Doppler sensor; processing the first velocity signal and the second velocity signal through an integration calculation; and determining a relative position of the printhead on the print medium along the first axis and the second axis with respect to an object.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a hand held printer in accordance with an embodiment of the present invention.

FIG. 2 is a general diagrammatic representation of the hand held printer of FIG. 1.

FIG. 3 is an enlarged bottom view of the hand held printer of FIG. 1.

FIG. 4 is a diagrammatic illustration of one of the Doppler sensors of the hand held printer of FIG. 1.

FIG. 5 is a flowchart of an exemplary method for determining a position of a printhead on a print medium, in accordance with an embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

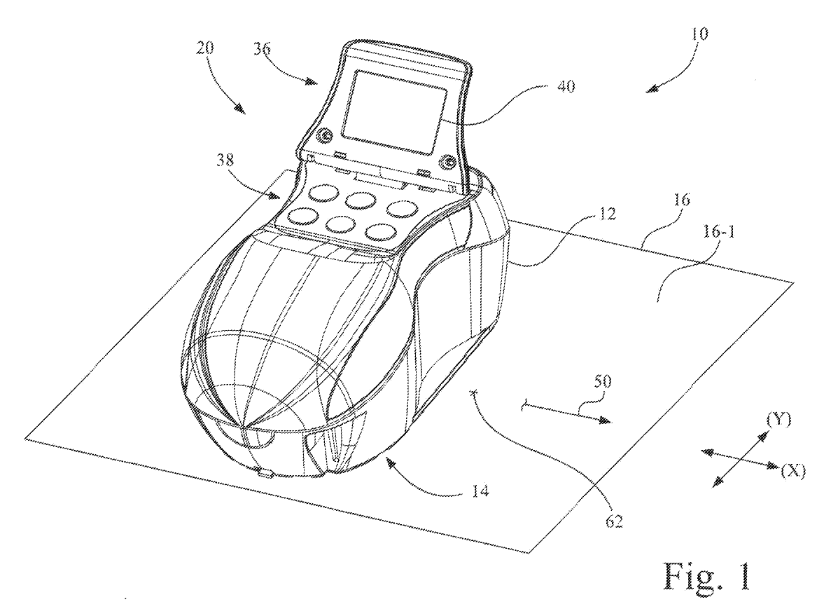

Referring now to the drawings and particularly to FIG. 1, there is shown a perspective view of a hand held printer 10. Hand held printer 10 includes a body 12. Body 12 is configured with a bottom surface 14, e.g., a smooth surface, that contacts a print medium 16, such as for example, a sheet of paper, transparency, card stock, fabric, hard surface, soft surface, etc. During operation, a user provides the motive force to provide movement of hand held printer 10 relative to surface 16-1 of print medium 16.

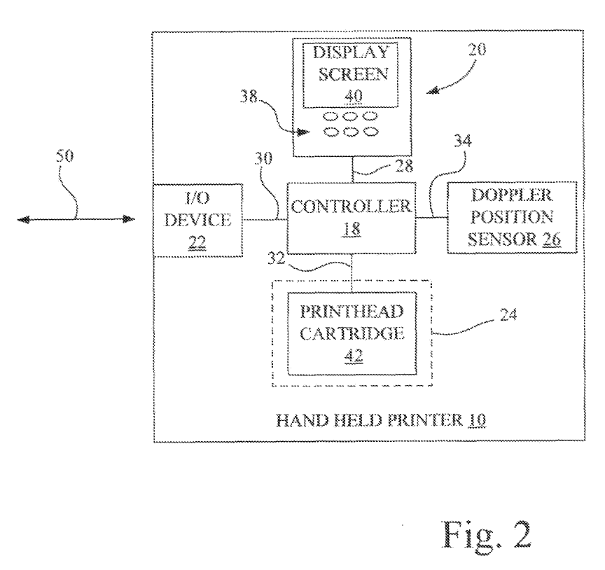

FIG. 2 is a general diagrammatic representation of hand held printer 10. Hand held printer 10 may be, for example, a hand held ink jet printer, and may include a controller 18, an operator panel 20, an input/output (I/O) device 22, a cartridge receptacle 24, and a Doppler receptacle 24, and Doppler position sensor 26 is mounted to body 12.

Controller 18 includes a processor unit and associated memory, and may be formed as one or more Application Specific Integrated Circuits (ASIC). Controller 18 executes program instructions to perform data processing and formatting, facilitate device control, and/or facilitate device interaction with respect to a plurality of devices in communication with controller 18. Controller 18 is communicatively coupled to operate panel 20 via communications link 28. Controller 18 is communicatively coupled to I/O device 22 via communications link 30. Controller 18 is communicatively coupled to cartridge receptacle 24 via a communications link 32. Controller 18 is communicatively coupled to Doppler position sensor 26 via a communications link 34. As used herein, the term “communications link” generally refers to structure that facilitates electronic communication between components, and may operate using wired or wireless technology.

As shown in FIGS. 1 and 2, operator panel 20 includes a display device 36, coupled by hinges to body 12, and a plurality of control buttons 38. Display device 36 and control buttons 38 are communicatively coupled to controller 18 via communications link 28. Display device 36 includes a display screen 40, which may be, for example, a liquid crystal display (LCD) having, for example, a resolution (height×width) of 81×101 pixels. Control buttons 38 may include, for example, a POWER button, a PRINT, etc. Of course, the number of buttons and their associated function may depend on the actual configuration of the hand held printer and the applications for which the hand held printer may be used.

I/O device 22 may be configured in a variety of ways, depending on the source and/or destination of the communicated content. For example, I/O device 22 may be a wired or wireless communication device that provides a communications link to a host computer, or some other intelligent device, that may supply image data for printing by hand held printer 10. Alternatively, I/O device 22 may be a local source of image content, such as for example, a memory card reader and associated memory card.

Cartridge receptacle 24, for example, may be formed in body 12 and configured for receiving and mounting at least one printhead cartridge 42. Cartridge receptacle 24 holds printhead cartridge 42 in a fixed position relative to, i.e., is removable yet fixedly mounted to, hand held printer 10. Printhead cartridge 42 is communicatively coupled to controller 18 via communications link 32.

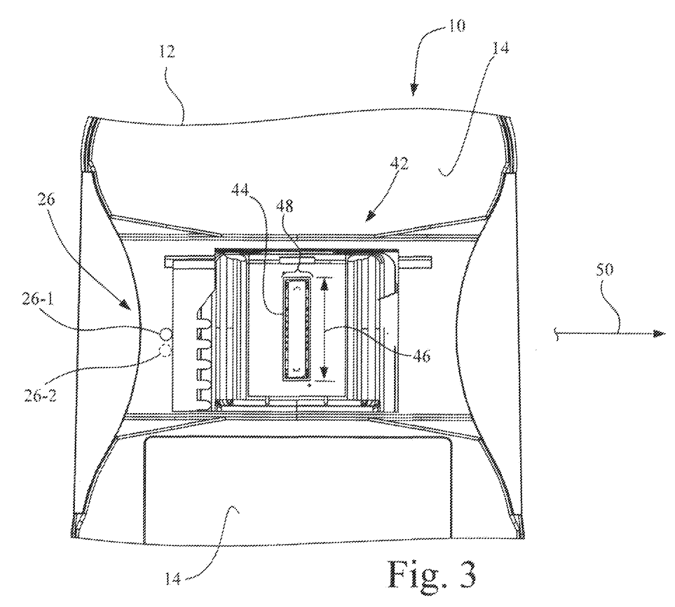

As shown in the example of FIG. 3, printhead cartridge 42 includes a printhead 44 and a supply of ink (not shown), to which controller 18 is communicatively coupled via communications link 32. Printhead 44 may, for example, have a printhead height 46 of 0.5 inches, and may be formed by a plurality of ink jetting nozzles 48 arranged in one or more columns. The printhead 44 may have for example 300 nozzles, and assuming a spacing between nozzles is 1/600^{th} of an inch, the vertical resolution of printhead 44 is 600 dpi (dots per inch).

The bottom surface 14 of body 12 contacts print medium 16 to provide the desired spacing between printhead 44 and the printing surface of print medium 16. Movement of the hand held printer 10 relative to print medium 16 in a travel direction 50, e.g., a horizontal path, results in relative movement of printhead cartridge 42 and printhead 44 with respect to a printing surface of print medium 16, which is sensed by Doppler position sensor 26.

Doppler position sensor 26 is mounted to body 12 of hand held printer 10, and is positioned adjacent bottom surface 14 to provide sensing at the underside of hand held printer 10, as shown in FIG. 3, and may be configured to sense movement of hand held printer 10 in one or more directions so to determine a position of hand held printer 10 relative to a location on print medium 16, e.g., a print position. Doppler position sensor 26 does not use pattern detection and tracking as used in hand held printers using conventional optical sensors. Rather, Doppler position sensor 26 uses interferometry of reflected laser light to detect motion so as to facilitate the computation of a position of hand held printer 10. In other words. Doppler position sensor 26 is a laser tracking sensor that measures the magnitude of the light reflected, i.e., returned, from the irregularities of surface 16-1 of print medium 16, and as such is less susceptible to variations in surface 16-1 of print medium 16 than a conventional optical sensor.

In the embodiment shown in FIG. 3, Doppler position sensor 26 may include for example, a first Doppler sensor 26-1, or alternatively as represented in dashed lines, first Doppler sensor 26-1 may be combined with a second Doppler sensor 26-2 to provide two-dimensional sensing. One such sensor suitable for use as Doppler sensor 26-1 and/or 26-2 is the PLN2020 Twin-eye™ laser sensor available from Philips Electronics.

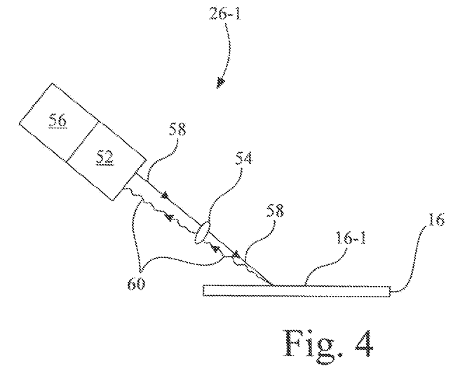

FIG. 4 illustrates the general concepts of motion sensing using Doppler sensor 26-1. Doppler sensor 26-1 includes an infrared laser 52, a lens 54 and an infrared sensor 56. Infrared sensor 56 may be, for example, an optical diode. Infrared laser 52 generates a source light beam 58 that is focused by lens 54 onto a target surface, e.g., surface 16-1 of print medium 16. The irregularities of surface 16-1 of print medium 16 scatters source light beam 58, and some of the returned light 60 is received at infrared sensor 56 of Doppler sensor 26-1 where the returned light 60 optically mixes with source light beam 58. The motion of hand held printer 10 relative to the irregularities of surface 16-1 of print medium 16, e.g., with the irregularities of surface 16-1 of print medium 16 toward or away from infrared laser 52 causes a Doppler shift in the frequency of the returned light 60. This shift in the frequency of the returned light 60 is proportional to the velocity, i.e., speed, of the movement of hand held printer 10 relative to the irregularities of surface 16-1 of print medium 16.

Optical mixing of the returned light 60 with source light beam 58 results in fluctuations of the laser power at a frequency proportional to the speed hand held printer 10 relative to the irregularities of surface 16-1 of print medium 16, and these fluctuations are sensed by infrared sensor 56. Infrared sensor 56 of first Doppler sensor 26-1 supplies a signal representing the fluctuations of the laser power to controller 18.

In embodiments wherein Doppler position sensor 26 includes a single Doppler sensor 26-1, first Doppler sensor 26-1 is located at a fixed location on hand held printer 10 in relation to printhead 44. Doppler sensor 26-1 generates a first velocity signal related to motion of hand held printer 10 along an axis, e.g., the X-axis (X). Controller 18 executes the program steps of a laser interferometry processing algorithm to process the velocity signal supplied by first Doppler sensor 26-1, wherein a single value of motion can be recorded directly for the field of view first Doppler sensor 26-1. Conversion from instantaneous velocity to position may be made by controller 18 by processing the velocity signal(s) through a simple integration calculation. Accordingly, by knowing the relative position of Doppler sensor 26-1 with respect to an object 62, controller 18 determines the relative position of printhead 44 on print medium 16 with respect to that same object 62 relative to a first axis of motion, e.g., an X-axis (X). Object 62 may be, for example, a start print position on print medium 16, an edge of print medium 16, of some other reference location on print medium 16.

In an embodiment where Doppler position sensor 26 includes both first Doppler sensor 26-1 and second Doppler sensor 26-2, fist Doppler sensor 26-1 and second Doppler sensor 26-2 are located at a fixed location on hand held printer 10 in relation to printhead 44. Second Doppler sensor 26-2 is positioned adjacent bottom surface 14 of hand held printer 10 spaced apart from first Doppler sensor 26-1, e.g., by two to ten millimeters, so that a small angular rotation of hand held printer 10 can be accurately detected. Doppler position sensor 26 sends the collected two-dimensional velocity data, e.g., X-axis (X) and Y-axis (Y) velocity data, to controller 18 via communications link 34.

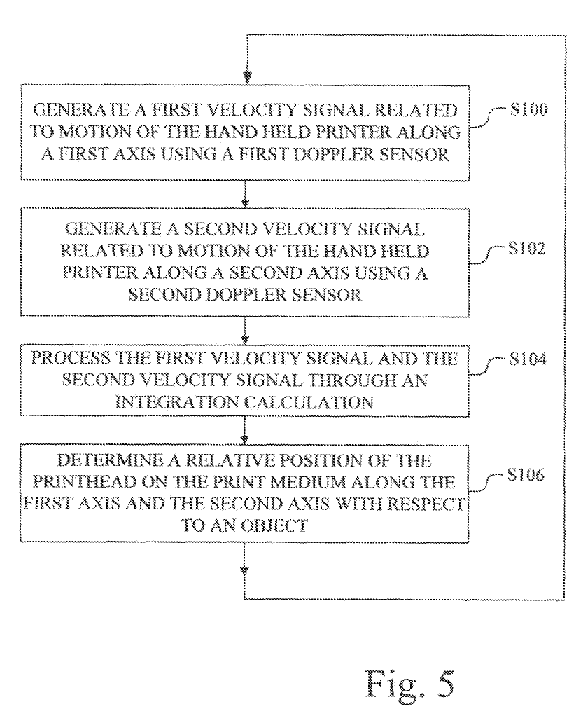

FIG. 5 is a flowchart of an exemplary method for determining a position of a printhead, e.g., printhead 44, on a print medium, e.g., print medium 16, in accordance with an embodiment of the present invention. In accordance with the method, controller 18 executes program instructions to process the two-dimensional position data generated by Doppler position sensor 26.

At step S100, Doppler sensor 26-1 generates a fist velocity signal related to motion of hand held printer 10 along an axis, e.g., the X-axis (X).

At step S102, Doppler sensor 26-2 generates a second velocity signal related to motion of hand held printer 10 along another axis, e.g., the Y-axis (Y).

At step S104, controller 18 executes the program steps of a laser interferometry processing algorithm to process the velocity signals supplied by first Doppler sensor 26-1 and second Doppler sensor 26-2, wherein a single value of motion can be recorded directly for the field of view first Doppler sensor 26-1 and a single value of motion can be recorded directly for the field of view second Doppler sensor 26-2. Conversion from instantaneous velocity to position may be made by controller 18 by processing each of the velocity signals through an integration calculation.

At step S106, by knowing the relative position of first Doppler sensor 26-1 and second Doppler sensor 26-2 with respect to an object 62, e.g., a start print position on print medium 16, and the velocity of hand held printer 10 along the X-axis (X) and the Y-axis (Y), controller 18 determines the relative position of printhead 44 on print medium 16 with respect to that same object 62 as hand held printer 10 is moved along the X-axis (X) and the Y-axis (Y).

While this invention has been described with respect to embodiments of the invention , the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hand held printer for printing on a print medium, comprising:
a body;
a printhead fixedly mounted to said body of said hand held printer;
a Doppler position sensor mounted to said body; and
a controller communicatively coupled to each of said printhead and said Doppler position sensor, said controller executing program instructions to read a velocity signal received from said Doppler position sensor and process said velocity signal to determine a position of said printhead on said print medium relative to at least one of a first axis and a second axis.

2. The hand held printer of claim 1, said Doppler position sensor including a first Doppler sensor generating a fist velocity signal related to motion of said hand held printer along said first axis, said controller executing program instructions to read said first velocity signal received from said first Doppler sensor and processing said first velocity signal to determine a position of said printhead on said print medium relative to said first axis.

3. The hand held printer of claim 2, said Doppler position sensor including a second Doppler sensor generating a second velocity signal related to motion of said hand held printer along said second axis, said second Doppler sensor being spaced apart from said first Doppler sensor, said controller executing program instructions to read said second velocity signal received from said second Doppler sensor and processing said second velocity signal to determine a position of said printhead on said print medium relative to said second axis.

4. A hand held printer for printing on a print medium, comprising:
a body;
a printhead fixedly mounted to said body of said hand held printer, said printhead having a plurality of ink jetting nozzles;
a first Doppler sensor mounted to said body, said first Doppler sensor generating a first velocity signal related to motion of said hand held printer along a first axis;
a second Doppler sensor mounted to said body, and spaced apart from said first Doppler sensor, said second Doppler sensor generating a second velocity signal related to motion of said hand held printer along a second axis; and
a controller communicatively coupled to each of said printhead, said first Doppler sensor, and said second Doppler sensor, said controller executing program steps to:
process said first velocity signal and said second velocity signal through an integration calculation, and
determine a relative position of said printhead on said print medium along said first axis and said second axis with respect to an object.

5. The hand held printer of claim 4, wherein said object is a reference position on said print medium.

6. The hand held printer of claim 5, wherein said reference position on said print medium is a start print position.

7. A method for determining a position of a printhead on a print medium, comprising:
generating a first velocity signal related to motion of said hand held printer along a first axis using a first Doppler sensor;
generating a second velocity signal related to motion of said hand held printer along a second axis using a second Doppler sensor;
processing said first velocity signal and said second velocity signal through an integration calculation; and
determining a relative position of said printhead on said print medium along said first axis and said second axis with respect to an object.

8. The method of claim 7, wherein said object is a reference position on said print medium.

9. The hand held printer of claim 8, wherein said reference position on said print medium is a start print position.
